(19) United States
(12) Patent Application Publication
(10) Pub. No.: US 2026/0365777 A1
(43) Pub. Date: Nov. 19, 2026

(54) POLYURETHANE FOAM AND COMPOSITION FOR POLYURETHANE FOAM PRODUCTION

(71) Applicant: INOAC CORPORATION, Aichi (JP)

(72) Inventor: Yasunari KOJIMA, Aichi (JP)

(73) Assignee: INOAC CORPORATION, Aichi (JP)

(21) Appl. No.: 19/133,804

(22) PCT Filed: Dec. 19, 2023
(86) PCT No.: PCT/JP2023/045528

§ 371 Date: May 29, 2025

(30) Foreign Application Priority Data
Dec. 21, 2022 (JP) 2022-204444

(51) Int. Cl. C08G 18/46; C08G 18/32; C08G 18/50; C08G 101/00

(52) U.S. Cl. CPC C08G 18/4623; C08G 18/3221; C08G 18/5024; C08G 2101/00; C08G 2230/00

(57) ABSTRACT

[Problems] To provide a technology for producing a novel polyurethane foam that can reduce the environmental impact.

[Solution] This technology provides a polyurethane foam that has a biodegradation degree of 15% or less after 45 days and a biodegradation degree of 30% or more after 180 days in the ISO 14885-2 biodegradation degree test. This technology also provides a composition for polyurethane foam production, which contains a polyol and a biomass-derived isocyanate, and a polyurethane foam formed using the composition for polyurethane foam production.

### TECHNICAL FIELD

The present technology relates to polyurethane foams and compositions for polyurethane foam production.

### BACKGROUND ART

Polyurethane foams are widely used in a variety of fields, including furniture such as sofas and chairs, bedding such as mattresses and pillows, clothing such as underwear, daily necessities such as dish sponges and cleaning sponges, interior products for vehicles and aircraft such as car seats, toys and miscellaneous goods. Various developments are being carried out to improve quality and impart new functions according to each field and purpose.

In recent years, in order to contribute to the formation of a sustainable society, a technology for producing a foamed body using a biomass resource has also been proposed. For example, Patent Literature 1 discloses a rigid polyurethane foamed body produced using a prepolymer that is a reaction product of at least one polyisocyanate component, at least one hydroxy-functional acrylate component, and at least one polyol component that is a biopolymer containing castor oil, soybean oil, etc.

In addition, in order to be environmentally friendly, a technology for producing a highly biodegradable foamed body has also been proposed. For example, Patent Literature 2 discloses a technology for producing a biodegradable polyurethane foamed body using a composition containing a mixture based on a poly(hydroxybutyrate) polymer, a polyol made from renewable sources, an isocyanate, and additives.

### CITATION LIST

### Patent Literature

Patent Literature 1: JP2007-522325 (Translation of PCT Application Publication)
Patent Literature 2: JP2009-527598 (Translation of PCT Application Publication)

### SUMMARY OF INVENTION

### Technical Problem

As mentioned above, technologies that use biomass resources and impart biodegradability to foamed bodies are being developed, but the reality is that further consideration for the environment is desired. Therefore, the main objective of this technology is to provide a technology for producing a novel polyurethane foam that can reduce the environmental load.

### Solution to Problem

First, the present technology provides a polyurethane foam having
a biodegradation degree after 45 days of 15% or less and
a biodegradation degree after 180 days of 30% or more
in the ISO 14885-2 biodegradation degree test.

The polyurethane foam according to the present technology can use a biomass-derived ester polyol as a raw material.

The polyurethane foam according to the present technology can also use a primary amine as a raw material.

Next, the present technology provides a composition for polyurethane foam production, containing
a polyol and
a biomass-derived isocyanate.

The polyol used in the composition for polyurethane foam production according to the present technology can contain a biomass-derived polyol.

The present technology also provides a polyurethane foam formed using the composition for polyurethane foam production according to the present technology.

The biomass degree of the polyurethane foam according to the present technology can be 50% or more.

### BRIEF DESCRIPTION OF DRAWING

FIG. 1 is a graph showing the time-dependent change in biodegradation degree over 180 days in Experimental Example 1.

### DESCRIPTION OF EMBODIMENTS

A preferred embodiment for carrying out the present technology will be described below. The embodiments described below are examples of typical embodiments of the present technology, and any of the embodiments can be combined. In addition, the scope of the present technology is not narrowly interpreted by these.

### First Embodiment

### 1. Polyurethane Foam

The polyurethane foam according to the present technology is characterized in that, in the ISO 14885-2 biodegradation degree test, the biodegradation degree after 45 days is 15% or less and the biodegradation degree after 180 days is 30% or more. Since the polyurethane foam according to the present technology has a biodegradation degree of 15% or less after 45 days, it is possible to prevent early deterioration and maintain quality for a certain period of time. Furthermore, since the polyurethane foam according to the present technology has a biodegradation degree of 30% or more after 180 days, it is possible to exhibit good biodegradability in a general environment.

The polyurethane foam according to the present technology may be any of flexible polyurethane foam, rigid polyurethane foam, and semi-rigid polyurethane foam, but is preferably flexible polyurethane foam. Specifically, it is preferable that the elongation is 50% or more, and more preferably that the elongation is 90% or more. A polyurethane foam having an elongation in this range is sufficiently flexible compared to semi-rigid and rigid polyurethane foams, and can be called a flexible polyurethane foam.

The hardness of the polyurethane foam according to the present technology is not particularly limited as long as it does not impair the purpose and effect of the present technology, but the lower limit is, for example, 10 or more, preferably 20 or more, more preferably 30 or more, and even more preferably 40 or more. The upper limit of the hardness of the polyurethane foam is, for example, 100 or less, preferably 90 or less, more preferably 80 or less, and even more preferably 70 or less. In the present technology, the hardness is a value measured with an Asker rubber hardness tester type F.

The foam density of the polyurethane foam according to the present technology is not particularly limited as long as it does not impair the purpose and effect of the present technology, but the lower limit is, for example, 20 kg/m³, preferably 40 kg/m³, more preferably 60 kg/m³, and even more preferably 70 kg/m³. The upper limit of the foam density of the polyurethane foam is, for example, 200 kg/m³, preferably 150 kg/m³, more preferably 100 kg/m³, and even more preferably 90 kg/m³. By setting the foam density within this range, the appearance of the polyurethane foam is further improved.

In the prior art, yeast fungi that decompose polyurethane were being developed, but these fungi were special decomposition fungi and had the problem of not being biodegradable in general environments. On the other hand, in the case of conventional foamed bodies that showed high biodegradability even in general environments, there were problems with rapid deterioration and poor quality retention. However, the polyurethane foam according to the present technology has good quality retention, despite being biodegradable in general environments.

The polyurethane foam according to the present technology can be used for various purposes in various fields by utilizing its high quality. For example, it can be suitably used for furniture such as sofas and chairs, bedding such as mattresses and pillows, clothing such as underwear, daily necessities such as dish sponges and cleaning sponges, interior products for vehicles and aircraft such as car seats, architectural joint materials, architectural cushioning materials, architectural sealing materials, electrical appliance sealing materials, soundproofing materials, packaging materials, vehicle insulation materials, dew prevention materials, interior materials, electrical appliance insulation materials, pipe insulation materials, various covers, cushioning materials, toys, miscellaneous goods, etc.

### 2. Composition for Polyurethane Foam Production

The polyurethane foam according to the present technology can use biomass-derived ester polyols and primary amines as raw materials. In addition, other materials that can be used as raw materials for general polyurethane foams can be freely selected and used as long as they do not impair the purpose and effects of the present technology. The composition for producing the polyurethane foam according to the present technology will be described below.

The composition for polyurethane foam production used in the present technology may contain a biodegradable polyol, an isocyanate, a primary amine, a foaming agent, a catalyst, a foam stabilizer, a biodegradation promoter, etc. Each component will be described in detail below.

### (1) Biodegradable Polyol

As the biodegradable polyol that can be used in the present technology, one or more types of biodegradable polyols that can be used in the production of polyurethane foam can be freely selected and used as long as the purpose and effect of the present technology are not impaired. Examples thereof include biomass-derived ester-based polyols having a hydroxyl group, such as polyglycolic acid (PGA), polylactic acid (PLA), polybutylene succinate (PBS), polybutylene succinate adipate (PBSA), polybutylene adipate terephthalate (PBAT), polycaprolactone (PCL), polyethylene glycol (PEG), polyvinyl alcohol (PVA), polyhydroxyalkanoic acid (PHA), cellulose, cellulose acetate, chitosan, starch, modified starch, xylitol, sorbitol, mannitol, maltitol, castor oil-based polyol, etc. Among these, in the present technology, it is preferable to use a biomass-derived ester-based polyol having a hydroxyl group, such as a castor oil-based polyol represented by the following chemical formula (1), and polycaprolactone (PCL) represented by the following chemical formula (2) may be used in combination. Note that, although it is preferable that all polyoles used are biodegradable polyols, other polyols may be mixed and used. The other polyols will be described in the second embodiment described later.

### [Chemical Formula 1]

### [Chemical Formula 2]

(m and n are integers of 1 or more)

In the composition for polyurethane foam production according to the present technology, the content of the biodegradable polyol relative to 100 parts by mass of the polyol is, for example, 50 parts by mass or more, preferably 55 parts by mass or more, more preferably 60 parts by mass or more, and even more preferably 65 parts by mass or more. By setting the content of the biodegradable polyol relative to 100 parts by mass of the polyol within this range, the effect of reducing the environmental load can be improved.

In the composition for polyurethane foam production according to the present technology, the upper limit of the content of the biodegradable polyol relative to 100 parts by mass of the polyol is not particularly limited as long as it does not impair the operation and effect of the present technology, and in consideration of biodegradability, it is preferable that all polyols used are biodegradable polyols. The upper limit of the content of the plant-derived polyol relative to 100 parts by mass of polyol can be set to, for example, 100 parts by mass or less, 90 parts by mass or less, 85 parts by mass or less, 80 parts by mass or less, 75 parts by mass or less, 70 parts by mass or less, etc.

### (2) Isocyanate

The isocyanate that can be used in the present technology can be freely selected from one or more types of isocyanates that can be used in the production of polyurethane foam, as long as the purpose and effect of the present technology are not impaired. Examples of the isocyanate that can be used in the present technology include aromatic isocyanates, aliphatic isocyanates, and alicyclic isocyanates.

Examples of the aromatic isocyanates that can be used in the present technology include 2,4-tolylene diisocyanate, 2,6-tolylene diisocyanate, m-phenylene diisocyanate, p-phenylene diisocyanate, 4,4′-diphenylmethane diisocyanate, 2,4′-diphenylmethane diisocyanate, 2,2′-diphenylmethane diisocyanate, xylylene diisocyanate, 3,3′-dimethyl-4,4′-biphenylene diisocyanate, and 3,3′-dimethoxy-4,4′-biphenylene diisocyanate.

In the present technology, it is preferable to use an aliphatic isocyanate and/or an alicyclic isocyanate as the isocyanate. Since aliphatic isocyanates and alicyclic isocyanates have a characteristic of being highly degradable, they can contribute to the environment. In the polyurethane foam according to the present technology, the ester bond portion derived from the polyol is hydrolyzed, and the urethane bond derived from the polyol and the isocyanate is hydrolyzed, so that the polyurethane foam is decomposed into an amine derived from the isocyanate, and a polyol. In the present technology, a highly degradable polyurethane foam can be produced by using aliphatic isocyanates and/or alicyclic isocyanates having degradability as the isocyanate.

Examples of the aliphatic isocyanates include trimethylene diisocyanate, 1,2-propylene diisocyanate, butylene diisocyanate (tetramethylene diisocyanate, 1,2-butylene diisocyanate, 2,3-butylene diisocyanate, 1,3-butylene diisocyanate), hexamethylene diisocyanate (HDI), pentamethylene diisocyanate, 2,2,4-trimethylhexamethylene diisocyanate, 2-4,4-trimethylhexamethylene diisocyanate, 2,6-diisocyanatomethyl caproate, lysine diisocyanate, trimethylhexamethylene diisocyanate, 1,5-pentamethylene diisocyanate (PDI), decamethylene diisocyanate, lysine ester triisocyanate, 1,6,11-undecane triisocyanate, 1,3,6-hexamethylene triisocyanate, and lysine triisocyanate (LTI (2,6-Diisocyanato hexanoic acid 2-isocyanatoethyl ester)).

Examples of the alicyclic isocyanate include monocyclic alicyclic isocyanates such as 1,3-cyclopentane diisocyanate, 1,3-cyclopentene diisocyanate, cyclohexane diisocyanate (1,4-cyclohexane diisocyanate, 1,3-cyclohexane diisocyanate), 3-isocyanatomethyl-3,5,5-trimethylcyclohexyl isocyanate (isophorone diisocyanate, IPDI), dimer acid diisocyanate, transcyclohexane 1,4-diisocyanate, hydrogenated tolylene diisocyanate (hydrogenated TDI), and hydrogenated tetramethylxylylene diisocyanate (hydrated TMXDI); and crosslinked cyclic alicyclic isocyanates such as norbornene diisocyanate, norbornane diisocyanate methyl, diisocyanatomethyl bicycloheptane, bicycloheptane triisocyanate, and di(diisocyanatomethyl)tricyclodecane.

Among these, in the present technology, it is preferable to select hexamethylene diisocyanate (HDI) isocyanurate (HDI trimer, 2,4,6-trioxo-1,3,5-triazine-1,3,5-triyltris(6,1-hexanediyl)triisocyanate) represented by the following chemical formula (3), which is a trimer of HDI; 1,5-pentamethylene diisocyanate (PDI) isocyanurate represented by the following chemical formula (4), which is a trimer of 1,5-PDI; and lysine triisocyanate (LTI (2,6-Diisocyanato hexanoic acid 2-isocyanatoethyl ester)) represented by the following chemical formula (5).

### [Chemical Formula 3]

### [Chemical Formula 4]

### [Chemical Formula 5]

The number of carbon atoms of the isocyanate used in the present technology is not particularly limited, but for example, when a trimer of isocyanate is used, the number of carbon atoms of the isocyanate monomer is preferably 6 or more.

The isocyanate group (NCO group) content (NCO %) in the isocyanate used in the present technology is, for example, 50% or less, for example, 40% or less, preferably 35% or less, and more preferably 30% or less.

The amount of isocyanate used in the present technology can be freely set as long as it does not impair the purpose and effect of the present technology. In the present technology, the lower limit of the isocyanate in the composition is, for example, 20 parts by mass or more, preferably 40 parts by mass or more, more preferably 50 parts by mass or more, even more preferably 60 parts by mass or more, and particularly preferably 70 parts by mass or more, relative to 100 parts by mass of polyol. By setting the lower limit of the content of isocyanate in the composition within this range, the foam shape of the polyurethane foam produced can be further improved.

In the present technology, the upper limit of the isocyanate content in the composition is, for example, 200 parts by mass or less, preferably 150 parts by mass or less, more preferably 130 parts by mass or less, and even more preferably 100 parts by mass or less, relative to 100 parts by mass of the polyol. Setting the upper limit of the isocyanate content in the composition within this range has a merit of reducing costs.

In the present technology, the isocyanate index can also be freely set as long as it does not impair the purpose and effect of the present technology. In the present technology, the lower limit of the isocyanate index is, for example, 60 or more, preferably 70 or more, and more preferably 80 or more. By setting the lower limit of the isocyanate index of the polyurethane foam within this range, the strength of the polyurethane foam produced can be improved.

In the present technology, the upper limit of the isocyanate index is, for example, not more than 130, preferably not more than 120, and more preferably not more than 110. Setting the upper limit of the isocyanate index content of the polyurethane foam within this range has the advantage of reducing costs, and also prevents the polyurethane foam from becoming too hard and brittle, which would result in a loss of flexibility, thereby improving the elasticity of the polyurethane foam.

In the present technology, the isocyanate index is a value calculated by [(isocyanate equivalent in the composition for polyurethane foam production/active hydrogen equivalent in the composition for polyurethane foam production)×100].

### (3) Primary Amines

In the present technology, a primary amine can be used. In particular, in the present technology, a primary amine having at least one primary amino group and an active hydrogen group such as a hydroxyl group and having two to four functional groups can be used.

When producing a polyurethane foam, the balance between the resinification reaction and the foaming reaction is very important. For example, if the resinification reaction is slower than the foaming reaction, the thickening of the composition for polyurethane foam production is also slower, so that the gas generated in the foaming reaction is more likely to escape, resulting in unstable foaming behavior. In addition, the cure time (hardening time) is also longer, which is not suitable for general mold molding, making mass production difficult, and the design of the produced polyurethane foam is also poor. However, in this technology, by using a primary amine, the initial thickening (cream time) can be accelerated, internal heat generation can be promoted, and the reactivity of the resinification reaction can be improved, while the reactivity of the foaming reaction can be increased to shorten the rise time. As a result, in order to improve the biodegradation degree, even when raw materials with low reactivity during production, such as aliphatic isocyanates and/or alicyclic isocyanates and biodegradable polyols, are used, the balance between the resinification reaction and the foaming reaction can be maintained well.

In addition, when a polyurethane foam is produced using a raw material with low reactivity during production, there is a method of increasing the amount of catalyst to increase the reactivity, but there is a problem that increasing the amount of catalyst makes the resinification reaction and the foaming reaction unstable. In addition, there is a method of shortening the reaction time by using a prepolymer in which a part of a polyol and/or an isocyanate has been reacted in advance as a raw material, but since the prepolymer has a high viscosity, there is a problem that the stirrability decreases due to the increase in the viscosity of the raw material mixture. However, in this technologiesince it is not necessary to increase the amount of catalyst by using a primary amine, the resinification reaction and the foaming reaction are stabilized. In addition, since the reactivity is high even without using a prepolymer, the increase in the viscosity of the raw material mixture can be suppressed and the stirrability can be prevented from decreasing.

The amount of the primary amine used in the composition for polyurethane foam production according to the present technology can be freely set as long as it does not impair the purpose and effect of the present technology. In the present technology, the lower limit of the content of the primary amine in the composition for polyurethane foam production is, for example, 0.5 parts by mass or more, preferably 1 part by mass or more, more preferably 2 parts by mass or more, relative to 100 parts by mass of polyol. By setting the lower limit of the content of the primary amine in the composition for polyurethane foam production within this range, the reactivity of the resinification reaction and the foaming reaction can be improved. As a result, even when a raw material with poor reactivity is used, the balance between the resinification reaction and the foaming reaction can be well maintained, and thus a polyurethane foam with excellent mechanical properties and design properties can be obtained.

In this technology, the upper limit of the content of the primary amine in the composition for polyurethane foam production is, for example, 20 parts by mass or less, preferably 15 parts by mass or less, more preferably 10 parts by mass or less, and even more preferably 7 parts by mass or less, relative to 100 parts by mass of polyol. By setting the upper limit of the content of the primary amine in the composition for polyurethane foam production within this range, it is possible to prevent instability of the resinification reaction and the foaming reaction due to excessively high reactivity during production, and to prevent a decrease in stirrability due to an increase in viscosity during prepolymerization. In addition, if the resinification reaction is too fast compared to the foaming reaction, curing may proceed before the foaming reaction proceeds, resulting in uneven foaming and hardness, or poor foaming, however, by setting the upper limit of the content of the primary amine in the composition for polyurethane foam production within this range, it is possible to maintain a good balance between the resinification reaction and the foaming reaction, and to prevent uneven foaming, uneven hardness, and poor foaming.

The number average molecular weight of the primary amine that can be used in the present technology is not particularly limited as long as it does not impair the purpose and effect of the present technology. The lower limit of the number average molecular weight of the primary amine that can be used in the present technology is, for example, 800 or more, preferably 1800 or more, and more preferably 2400 or more. In addition, the weight average molecular weight of the primary amine that can be used in the present technology is not particularly limited as long as it does not impair the purpose and effect of the present technology. The lower limit of the weight average molecular weight of the primary amine that can be used in the present technology is, for example, 800 or more, preferably 1800 or more, and more preferably 2400 or more. By setting the lower limit of the number average molecular weight and/or weight average molecular weight of the primary amine that can be used in the present technology within this range, it is possible to prevent instability of the resinification reaction and the foaming reaction due to excessively high reactivity during production, and also to prevent a decrease in stirrability due to an increase in the viscosity of the prepolymerization. In addition, it is possible to maintain a good balance between the resinification reaction and the foaming reaction, and to prevent uneven foaming, uneven hardness, and poor foaming.

The upper limit of the number average molecular weight of the primary amine that can be used in the present technology is, for example, 12000 or less, preferably 8000 or less, more preferably 6000 or less. The upper limit of the weight average molecular weight of the primary amine that can be used in the present technology is, for example, 12000 or less, preferably 8000 or less, more preferably 6000 or less. By setting the upper limit of the number average molecular weight and/or weight average molecular weight of the primary amine that can be used in the present technology within this range, the reactivity during production can be improved. As a result, even when a raw material with low reactivity is used, a good balance between the resinification reaction and the foaming reaction can be maintained, and a polyurethane foam with excellent mechanical properties and design properties can be obtained.

The number of oxyalkylene repeating units in the primary amine that can be used in the present technology is not particularly limited as long as it does not impair the purpose and effect of the present technology. The lower limit of the number of oxyalkylene repeating units in the primary amine that can be used in the present technology is, for example, 10 or more, preferably 20 or more, more preferably 30 or more, and even more preferably 40 or more. By setting the lower limit of the number of oxyalkylene repeating units in the primary amine that can be used in the present technology within this range, it is possible to prevent instability of the resinification reaction and the foaming reaction due to excessively high reactivity during production, and to prevent a decrease in stirrability due to an increase in viscosity during prepolymerization. In addition, it is possible to maintain a good balance between the resinification reaction and the foaming reaction, and to prevent uneven foaming, uneven hardness, and poor foaming.

The upper limit of the number of oxyalkylene repeating units in the primary amine that can be used in the present technology is, for example, 200 or less, preferably 160 or less, more preferably 120 or less, and even more preferably 100 or less. By setting the upper limit of the number of oxyalkylene repeating units in the primary amine that can be used in the present technology within this range, the reactivity during production can be improved. As a result, even when a raw material with poor reactivity is used, a good balance between the resinification reaction and the foaming reaction can be maintained, and a polyurethane foam with excellent mechanical properties and design properties can be obtained.

The kinetic viscosity of the primary amine usable in the present technology is not particularly limited as long as it does not impair the purpose and effect of the present technology. The lower limit of the kinetic viscosity of the primary amine usable in the present technology is, for example, 100 cSt or more, preferably 200 cSt or more, more preferably 300 cSt or more at 25 °C.

The upper limit of the kinematic viscosity of the primary amine that can be used in the present technology is, for example, 2000 cSt or less, preferably 1500 cSt or less, and more preferably 1000 cSt or less at 25 °C.

The amine hydrogen equivalent weight (AHEW) of the primary amine that can be used in the present technology is not particularly limited as long as it does not impair the purpose and effect of the present technology. The lower limit of the amine hydrogen equivalent weight (AHEW) of the primary amine that can be used in the present technology is, for example, 100 or more, preferably 200 or more, and more preferably 300 or more. By setting the lower limit of the amine hydrogen equivalent weight (AHEW) of the primary amine that can be used in the present technology within this range, it is possible to prevent instability of the resinification reaction due to excessively high reactivity during the resinification reaction, and also to prevent a decrease in stirrability due to an increase in viscosity during prepolymerization. In addition, it is possible to maintain a good balance between the resinification reaction and the foaming reaction, and to prevent uneven foaming, uneven hardness, and poor foaming.

The upper limit of the amine hydrogen equivalent weight (AHEW) of the primary amine that can be used in the present technology is, for example, 2000 or less, preferably 1500 or less, and more preferably 1000 or less. By setting the upper limit of the amine hydrogen equivalent weight (AHEW) of the primary amine that can be used in the present technology within this range, the reactivity of the resinification reaction can be improved. As a result, even when a raw material with low reactivity is used, a good balance between the resinification reaction and the foaming reaction can be maintained, and eventually a polyurethane foam with excellent mechanical properties can be obtained.

In the present technology, the amine hydrogen equivalent weight (AHEW) of a primary amine is defined as the molecular weight of a polyetheramine divided by the number of active amine hydrogens per molecule. The amine hydrogen equivalent weight (AHEW) of a primary amine can be calculated according to conventional technologies known to those skilled in the art, but preferably, it can be calculated by determining the content of amine group nitrogen using the procedure described in ISO9702.

Specific examples of primary amines that can be used in the present technology include one or more primary amines selected from polyester primary amines, polyether triamines obtained by addition polymerization of oxyalkylene represented by the following chemical formula (6), polyether primary amines such as poly(propylene glycol) triamine and polyoxypropylene diamine, and one or more of these primary amines can be freely selected and used.

### [Chemical Formula 6]

(n, x, y, and z are Each an Integer of 1 or More)

In addition, in the composition for polyurethane foam production according to the present technology, in addition to the primary amine, a secondary amine or a tertiary amine can be used as long as it does not impair the purpose and effect of the present technology. In this case, the ratio of the primary amine in the total amine is preferably 90% or more, more preferably 94% or more. By setting the ratio of the primary amine in the total amine within this range, the reactivity of the resinification reaction can be improved. As a result, even when a raw material with poor reactivity is used, the balance between the resinification reaction and the foaming reaction can be well maintained, and eventually a polyurethane foam with excellent mechanical properties can be obtained.

### (4) Foaming Agent

A foaming agent can be used in the composition for polyurethane foam production according to the present technology. As the foaming agent that can be used in the present technology, one or more types of foaming agents that can be used in the production of a polyurethane foam can be freely selected and used as long as the purpose and effect of the present technology are not impaired.

Examples of the foaming agent include water, hydrocarbons, and halogen-based compounds. Examples of the hydrocarbons include cyclopentane, isopentane, and normal pentane. Examples of the halogen-based compounds include methylene chloride, trichlorofluoromethane, dichlorodifluoromethane, nonafluorobutyl methyl ether, nonafluorobutyl ethyl ether, pentafluoroethyl methyl ether, and heptafluoroisopropyl methyl ether. In the present technology, it is preferable to use water as the foaming agent among these. The water may be any of ion-exchanged water, tap water, and distilled water.

The amount of the foaming agent used in the composition for polyurethane foam production according to the present technology can be freely set as long as it does not impair the purpose and effect of the present technology. In the present technology, the lower limit of the content of the foaming agent in the composition for polyurethane foam production is, for example, 0.1 parts by mass or more, preferably 0.5 parts by mass or more, more preferably 1 part by mass or more, relative to 100 parts by mass of polyol. By setting the lower limit of the content of the foaming agent in the composition for polyurethane foam production within this range, it is possible to improve the foamability, and as a result, it is possible to obtain a polyurethane foam having excellent mechanical properties and appearance.

In the present technology, the upper limit of the content of the foaming agent in the composition for polyurethane foam production is, for example, 10 parts by mass or less, preferably 8 parts by mass or less, and more preferably 5 parts by mass or less, relative to 100 parts by mass of the polyol. By setting the upper limit of the content of the foaming agent in the composition for polyurethane foam production within this range, formation defects due to excessive foaming can be suppressed and also contribute to cost reduction.

### (5) Catalyst

A catalyst can be used in the composition for polyurethane foam production according to the present technology. As the catalyst that can be used in the present technology, one or more types of catalysts that can be used in the production of polyurethane foam can be freely selected and used as long as the purpose and effect of the present technology are not impaired.

Examples of the catalyst include tin catalysts such as tin neodecanoate, dibutyltin dilaurate, and stannous octoate, and metal catalysts (organometallic catalysts) such as phenylmercury propionate and lead octenate. In addition, amine catalysts such as triethylamine, triethylenediamine (TEDA), tetramethylguanidine, diethanolamine, bis(2-dimethylaminoethyl) ether, N,N,N′,N″,N″-pentamethyldiethylenetriamine, imidazole-based compounds, piperazine-based amines such as dimethylpiperazine, N-methyl-N′-(2-dimethylamino)ethylpiperazine, and N-methyl-N′-(2-hydroxyethyl) piperazine, morpholine-based amines such as N-methylmorpholine and N-ethylmorpholine, amines called DBU homologues, such as 1,8-diazabicyclo-[5,4,0]-undecene-7 (DBU), 1,5-diazabicyclo-[4,3,0]-nonene-5 (DBN), 1,8-diazabicyclo-[5,3,0]-decene-7 (DBD), and 1,4-diazabicyclo-[3,3,0]-octene-4 (DBO), can also be used, and among these amine catalysts, tertiary amine catalysts and secondary amine catalysts are preferred, and those having a molecular weight of less than 700 are more preferred, those having a molecular weight of less than 500 are even more preferred, and those having a molecular weight of less than 300 are even more preferred.

The amount of catalyst used in the composition for polyurethane foam production according to the present technology can be freely set as long as it does not impair the purpose and effect of the present technology. In the present technology, the lower limit of the catalyst content in the composition for polyurethane foam production is, for example, 0.1 parts by mass or more, preferably 0.5 parts by mass or more, more preferably 1 part by mass or more, relative to 100 parts by mass of polyol. By setting the lower limit of the catalyst content in the composition for polyurethane foam production within this range, the resinification reaction and the foaming reaction can be promoted, and as a result, a polyurethane foam having excellent mechanical properties and appearance can be obtained.

In the present technology, the upper limit of the catalyst content in the composition for polyurethane foam production is, for example, 30 parts by mass or less, preferably 25 parts by mass or less, and more preferably 20 parts by mass or less, relative to 100 parts by mass of polyol. By setting the upper limit of the catalyst content in the composition for polyurethane foam production within this range, it is possible to prevent instability of the resinification reaction and the foaming reaction, and to maintain a good balance between the resinification reaction and the foaming reaction. As a result, it is possible to obtain a polyurethane foam with excellent mechanical properties and appearance.

### (6) Foam Stabilizer

A foam stabilizer can be used in the composition for polyurethane foam production according to the present technology. As the foam stabilizer that can be used in the present technology, one or more types of foam stabilizers that can be used in the production of polyurethane foam can be freely selected and used as long as the purpose and effect of the present technology are not impaired.

Examples of the foam stabilizer include silicone foam stabilizers, fluorine-containing compound-based foam stabilizers, surfactants, etc. Examples of the silicone foam stabilizer include those mainly composed of siloxane chains, those in which the siloxane chain and polyether chain have a linear structure, those that diverge and are branched, and those in which the polyether chain is modified to be pendant to the siloxane chain.

The amount of the foam stabilizer used in the composition for polyurethane foam production according to the present technology can be freely set as long as it does not impair the purpose and effect of the present technology. In the present technology, the lower limit of the content of the foam stabilizer in the composition for polyurethane foam production is, for example, 0.1 parts by mass or more, preferably 0.3 parts by mass or more, more preferably 0.5 parts by mass or more, relative to 100 parts by mass of polyol. By setting the lower limit of the content of the foam stabilizer in the composition for polyurethane foam production within this range, the foaming reaction can be stabilized, and as a result, a polyurethane foam having excellent mechanical properties and appearance can be obtained.

In the present technology, the upper limit of the content of the foam stabilizer in the composition for polyurethane foam production is, for example, 10 parts by mass or less, preferably 7 parts by mass or less, and more preferably 5 parts by mass or less, relative to 100 parts by mass of the polyol. Setting the upper limit of the content of the foam stabilizer in the composition for polyurethane foam production within this range can contribute to cost reduction.

### (7) Biodegradation Promoter

In the composition for polyurethane foam production according to the present technology, a biodegradation promoter may be used. By using the biodegradation promoter, when a biodegradable raw material is used as a raw material for the polyurethane foam according to the present technology, the biodegradability can be improved.

As the biodegradation promoter that can be used in the present technology, one or more biodegradation types of promoters that can be used in polyurethane foams can be freely selected and used, as long as they do not impair the purpose and effect of the present technology.

Examples of the biodegradation promoter include sugars such as glucose, xylose, galactose, maltose, sucrose, chitin, and cellulose; starches; amino acids; peptides; gums such as tamarind gum; and lignin.

The amount of the biodegradation promoter used in the composition for polyurethane foam production according to the present technology can be freely set as long as it does not impair the purpose and effects of the present technology. In the present technology, the lower limit of the content of the biodegradation promoter in the composition for polyurethane foam production is, for example, 0.1 parts by mass or more, preferably 0.5 parts by mass or more, and more preferably 1 part by mass or more, relative to 100 parts by mass of polyol.

In the present technology, the upper limit of the content of the biodegradation promoter in the composition for polyurethane foam production is, for example, 10 parts by mass or less, preferably 7 parts by mass or less, and more preferably 5 parts by mass or less, per 100 parts by mass of polyol.

### (8) Other

In the composition for polyurethane foam production according to the present technology, one or more types of various components that can be used in compositions for polyurethane foam production can be freely selected and used as other components depending on the purpose, as long as the purpose and effects of the present technology are not impaired.

Examples of components that can be used in the composition for polyurethane foam production according to the present technology include flame retardants, stabilizers, plasticizers, colorants, antioxidants, crosslinking agents, antibacterial agents, dispersants, and ultraviolet absorbers.

### 3. Production Method of Polyurethane Foam

The polyurethane foam according to the present technology can be produced by preparing a composition by mixing each component of the composition for polyurethane foam production according to the present technology described above, and proceeding with a resinification reaction and a foaming reaction. As the method of the resinification reaction and the foaming reaction, any general method can be freely combined and used as long as it does not impair the purpose and effect of the present technology.

In the method for polyurethane foam production according to the present technology, either slab foaming or mold foaming can be used for the foaming. Slab foaming is a method in which a composition for polyurethane foam production (raw material for polyurethane foam) is mixed and discharged onto a belt conveyer, and foamed at atmospheric pressure and room temperature. On the other hand, mold foaming is a method in which a composition for polyurethane foam production (raw material for polyurethane foam) is mixed and injected into a cavity of a mold (metal mold), and foamed into the shape of the cavity. In the present technology, mold foaming is preferably used from the viewpoint of ease of production. As described above, in the present technology, by using a primary amine, it is possible to perform mold molding even when a large amount of raw material derived from biomass is used.

### Second Embodiment

### 1. Composition for Polyurethane Foam Production

The composition for polyurethane foam production according to the present technology contains a polyol and a biomass-derived isocyanate. In addition, a primary amine, a foaming agent, a catalyst, a foam stabilizer, a biodegradation promoter, etc. can be contained as necessary. Each component will be described in detail below. The details of the primary amine, the foaming agent, the catalyst, the foam stabilizer, and the biodegradation promoter are the same as those of the first embodiment described above, so that the description will be omitted here.

### (1) Polyol

In the present technology, one or more types of polyols that can be used in the production of polyurethane foam can be freely selected and used in combination. Examples of the polyols include polyester polyols, polycarbonate polyols, polyester ether polyols, polycaprolactone polyols, and polylactic acid polyols.

Examples of the polyether polyols include polyethylene glycol, polypropylene glycol, polytetramethylene ether glycol, etc., which are obtained by polymerizing cyclic ethers such as ethylene oxide and propylene oxide, respectively, and copolyethers thereof. In addition, polyhydric alcohols such as glycerin and trimethylolethane can be used to polymerize the cyclic ethers to obtain the polyether polyols. In addition, commercially available polyether polyols can be used.

Also, as the polyether polyol, a polymer polyol can be used. The polymer polyol is obtained by polymerizing an ethylenically unsaturated monomer in a polyether polyol, or by emulsifying and dispersing a polymer of an ethylenically unsaturated monomer in a polyether polyol. Specifically, for example, a polyether polyol is graft-polymerized with acrylonitrile, styrene, or the like, or polystyrene or polyacrylonitrile is dispersed in a polyether polyol, or the like.

Examples of the polyester polyols include polyester polyols obtained by a dehydration condensation reaction of aliphatic dicarboxylic acids such as succinic acid, adipic acid, sebacic acid, and azelaic acid; aliphatic carboxylic acids such as ricinoleic acid; aromatic dicarboxylic acids such as phthalic acid, terephthalic acid, isophthalic acid, and naphthalenedicarboxylic acid; alicyclic dicarboxylic acids such as hexahydrophthalic acid, hexahydroterephthalic acid, and hexahydroisophthalic acid; or acid esters or acid anhydrides thereof with ethylene glycol, 1,3-propylene glycol, 1,2-propylene glycol, 1,3-butanediol, 1,4-butanediol, 1,5-pentanediol, 1,6-hexanediol, 3-methyl-1,5-pentanediol, neopentyl glycol, 1,8-octanediol, 1,9-nonanediol, or a mixture thereof; and polylactone polyols and polycaprolactone polyols obtained by ring-opening polymerization of lactone monomers such as s-caprolactone and methylvalerolactone. In addition to these, examples of the polyester polyols include naturally occurring polyols having ester groups.

Examples of the polycarbonate polyols include those obtained by reacting at least one of polyhydric alcohols such as ethylene glycol, 1,2-propylene glycol, 1,3-propylene glycol, 1,3-butanediol, 1,4-butanediol, 1,5-pentanediol, 1,6-hexanediol, 3-methyl-1,5-pentanediol, neopentyl glycol, 1,8-octanediol, 1,9-nonanediol, and diethylene glycol with diethylene carbonate, dimethyl carbonate, diethyl carbonate, or the like.

Examples of the polyester ether polyols include those obtained by a dehydration condensation reaction of an aliphatic dicarboxylic acid such as succinic acid, adipic acid, sebacic acid, or azelaic acid; an aromatic dicarboxylic acid such as phthalic acid, terephthalic acid, isophthalic acid, or naphthalenedicarboxylic acid; an alicyclic dicarboxylic acid such as hexahydrophthalic acid, hexahydroterephthalic acid, or hexahydroisophthalic acid; or an acid ester or anhydride thereof with a glycol such as diethylene glycol or a propylene oxide adduct, or a mixture thereof.

In the present technology, it is preferable to use a biomass-derived polyol as the polyol. As the biomass-derived polyol that can be used in the present technology, one or more types of biomass-derived polyols that can be used in the production of polyurethane foam can be freely selected and used as long as the operation and effect of the present technology are not impaired.

Examples of the biomass-derived polyols that can be used in the present technology include polyols derived from natural fats and oils. Natural fat-derived polyols are natural fats and oils such as castor oil, soybean oil, rapeseed oil, and coconut oil, or derivatives thereof (modified natural fat and oil polyols, unmodified natural fat and oil polyols, etc.), which contain hydroxyl groups on the hydrocarbon chain and have two or more hydroxyl groups in one molecule. In the present technology, two or more types of these may be used in combination. Other biomass-derived polyols include, for example, corn-derived polyols and cashew nut shell liquid-derived polyols. In addition, commercially available biomass-derived polyols may be used.

Among these, in the present technology, it is preferable to use castor oil. “Castor oil” includes unmodified castor oil, modified castor oil, dehydrated castor oil, hydrogenated castor oil, etc. More specifically, it is preferable to use a castor oil-based polyol represented by the above chemical formula (1).

In the composition for polyurethane foam production according to the present technology, the content of the biomass-derived polyol relative to 100 parts by mass of the polyol is, for example, 45 parts by mass or more, preferably 65 parts by mass or more, more preferably 85 parts by mass or more, and even more preferably 95 parts by mass or more. By setting the content of the biomass-derived polyol relative to 100 parts by mass of the polyol within this range, the effect of reducing the environmental load can be improved.

In the composition for polyurethane foam production according to the present technology, the upper limit of the content of the biomass-derived polyol relative to 100 parts by mass of polyol is not particularly limited as long as it does not impair the operation and effect of the present technology, and in consideration of reducing the environmental load, it is preferable that all polyols used are biomass-derived polyols. The upper limit of the content of the biomass-derived polyol relative to 100 parts by mass of polyol can be set to, for example, 100 parts by mass or less, 90 parts by mass or less, 85 parts by mass or less, 80 parts by mass or less, 75 parts by mass or less, 70 parts by mass or less, etc.

In the present technology, in consideration of the environment, a biodegradable polyol can also be used. Details of the biodegradable polyol are the same as those of the biodegradable polyol used in the first embodiment described above, and therefore a description thereof will be omitted here.

### (2) Biomass-Derived Isocyanates

The composition for polyurethane foam production according to the second embodiment is characterized in that a biomass-derived isocyanate is used as the isocyanate. By using the biomass-derived isocyanate, the biomass degree of the polyurethane foam produced can be increased, which can contribute to reducing the environmental load.

As the biomass-derived isocyanate, one or more types of biomass-derived isocyanates that can be used in the production of polyurethane foam can be freely selected and used as long as they do not impair the operation and effect of the present technology. Examples of such isocyanates include 1,5-pentamethylene diisocyanate (PDI), lysine triisocyanate (LTI (2,6-Diisocyanato hexanoic acid 2-isocyanatoethyl ester)), lysine diisocyanate (LDI (Hexanoic acid, 2,6-diisocyanato)), and dimer acid diisocyanate (DDI (3,4-dihexyl-5-(10-isocyanatodec-1-en-1-yl)-6-(8-isocyanatooctyl)cyclohex-1-ene)). Among these, in the present technology, it is preferable to select 1,5-PDI isocyanurate represented by the above chemical formula (4), which is a trimer of 1,5-pentamethylene diisocyanate (PDI); and lysine triisocyanate (LTI (2,6-Diisocyanato hexanoic acid 2-isocyanatoethyl ester)) represented by the above chemical formula (5).

In the present technology, in addition to the biomass-derived isocyanate, it is also possible to use other commonly used isocyanates such as petroleum-derived isocyanates in combination. Details of the other isocyanates are the same as those of the isocyanates that can be used in the first embodiment described above, and therefore will not be described here.

In the composition for polyurethane foam production according to the present technology, the content of the biomass-derived isocyanate relative to 100 parts by mass of isocyanate is, for example, 40 parts by mass or more, preferably 45 parts by mass or more, more preferably 50 parts by mass or more, and even more preferably 55 parts by mass or more. By setting the content of the biomass-derived isocyanate relative to 100 parts by mass of isocyanate within this range, the effect of reducing the environmental load can be improved.

In the composition for polyurethane foam production according to the present technology, the upper limit of the content of the biomass-derived isocyanate relative to 100 parts by mass of isocyanate is not particularly limited as long as it does not impair the operation and effect of the present technology, and in consideration of reducing the environmental load, it is preferable that all isocyanates used are biomass-derived isocyanates. The upper limit of the content of the biomass-derived isocyanate relative to 100 parts by mass of isocyanate can be set to, for example, 100 parts by mass or less, 90 parts by mass or less, 85 parts by mass or less, 80 parts by mass or less, 75 parts by mass or less, 70 parts by mass or less, etc.

The amount of biomass-derived isocyanate used in the present technology can be adjusted so as to achieve the amount of isocyanate and isocyanate index described in the first embodiment described above, and when used in combination with other isocyanates, the amount of the other isocyanates can also be taken into consideration.

### 2. Polyurethane Foam

The polyurethane foam of the second embodiment is a polyurethane foam produced using the composition for polyurethane foam production of the second embodiment described above.

The biodegradation degree of the polyurethane foam according to the second embodiment is not particularly limited, but similar to the polyurethane foam according to the first embodiment described above, in the biodegradation degree test of ISO 14885-2, it is preferable that the biodegradation degree after 45 days is 15% or less, and that the biodegradation degree after 180 days is 30% or more.

The biomass degree of the polyurethane foam according to the present technology can be freely set as long as it does not impair the operation and effect of the present technology. The lower limit of the biomass degree of the polyurethane foam according to the present technology is, for example, 20% or more, preferably 25% or more, more preferably 30% or more, even more preferably 35% or more, and particularly preferably 40% or more. The higher the biomass degree of the polyurethane foam according to the present technology, the more it contributes to the environment, so there is no upper limit on the biomass degree.

In this technology, the “biomass degree” is a value calculated using the following formula.

Biomass degree (%)={(weight of biomass material×biomass degree of biomass material/100)/weight of total raw materials}×100

The hardness, density, and other characteristics and uses of the polyurethane foam of the second embodiment are the same as those of the polyurethane foam of the first embodiment described above, so a description thereof will be omitted here.

### 3. Production Method of Polyurethane Foam

The polyurethane foam according to the second embodiment can be produced by mixing the components of the composition for polyurethane foam production according to the second embodiment described above to prepare a composition, and then allowing a resinification reaction and a foaming reaction to proceed. The details of the production method are the same as those of the production method for a polyurethane foam according to the first embodiment described above, and therefore a description thereof will be omitted here.

### EXAMPLES

The present technology will be described in more detail below based on examples. Note that the examples described below are representative examples of the present technology, and the scope of the present technology is not to be interpreted narrowly by these examples.

Unless otherwise specified, the materials used in the present examples are as follows.
Petroleum-derived polypropylene glycol polyol: Sanyo Chemical Industries, Ltd. “KC737”
Petroleum-derived polycaprolactone polyol 1: Daicel Corporation “Placcel 308”
Petroleum-derived polycaprolactone polyol 2: Daicel Corporation “Placcel 205U”
Biomass-derived refined castor oil (ricinoleic acid triglyceride): Itoh Oil Chemicals Co., Ltd. “H-30”
Biomass-derived sebacic acid ester polyol: Itoh Oil Chemicals Co., Ltd. “SE-2013C”
Petroleum-derived polyetheramine: Mitsui Fine Chemicals, Inc. “T5000”
Tin neodecanoate: Nitto Chemical Industry Co., Ltd. “Neostann U50”
TEDA (triethylenediamine): Evonik Japan Co., Ltd. “DABCO Crystal”
DBU (diazabicycloundecene): San-Apro Ltd. “U-CAT SA-102”
1,2-Dimethylimidazole (70%)+EG (30%): Evonik Japan Co., Ltd. “DABCO 2040”
Silicone foam stabilizer: Evonik Japan Co., Ltd. “B-8742LF2” (Comparative Examples 1 to 4, Examples 4 and 6), Momentive Performance Materials Japan LLC “L594plus” (Examples 1 to 3, 5, 7 and 8)
Diphenylmethane diisocyanate: Tosoh Corporation “Millionate NM”
Hexamethylene diisocyanate (HDI) trimer: Asahi Kasei Corporation “Duranate TLA-100”
Pentamethylene diisocyanate (PDI) trimer: Mitsui Chemicals, Inc. “STABIO D-376N”

### Experimental Example 1

In Experimental Example 1, the biodegradability of a polyurethane foam was examined.

### (1) Production of Polyurethane Foam

After preparing a composition by mixing the raw materials shown in Table 1 below, the composition was first poured into a foaming box (open without a lid) and allowed to foam freely to confirm reactivity and foam moldability (appearance and foam condition). Next, after preparing a composition by mixing the raw materials shown in Table 1 below, the composition was transferred to a mold and allowed to foam to produce each polyurethane foam.

### (2) Biodegradability Test

The produced polyurethane foams were subjected to a biodegradability test using the following method.

### [Soil Burial Test]

Compost was prepared by mixing 4 kg of chicken manure compost, 1 kg of cow manure compost, 20 g of superphosphate, and 100 g of bacteria, and then water was added at a weight ratio of compost:water=1:1 and mixed, and the mixture was then covered and cultured at room temperature for 24 hours and then further cultured at 58 °C for 24 hours. If the fully matured compost after culture had lost weight due to water evaporation, water was replenished to adjust the moisture content to 50-75%, and if the pH was 9 or higher, it was neutralized with acetic acid to adjust the pH to 7-9, thereby preparing fully matured compost.

The produced polyurethane foam test pieces (100×150×20 mm) were mixed with the prepared fully matured compost at a weight ratio of fully matured compost:test pieces of 15:1 (dry weight ratio 6:1), and the mixture was left in a sealed state at 58 °C. The weight and pH were checked periodically, and if there was a weight loss due to water evaporation, water was replenished to keep the moisture content at 50-75%, and if a decrease in compost was observed, a mixture of vermiculite and water (weight ratio 1:1) was added. If the pH was 9 or higher, it was neutralized with acetic acid to keep the pH at 7-9, and the inside was stirred at least once a week.

After 45 days from burying the test specimens, the specimens were removed while taking care not to collapse. After washing off any attached soil and the like with water, the specimens were dried in a thermostatic chamber at 60 °C for 24 hours, and the weight loss rate was calculated using the following formula.

{(weight before burial−weight after 45 days)/(weight before burial)}×100=weight loss rate (%)

### [Biodegradation Degree]

The biodegradation degree over 180 days was measured, for Example 1, Comparative Examples 1 and 2, and Example 5 produced in Experimental Example 2 described later, in accordance with ISO 14855-2.

### (3) Results

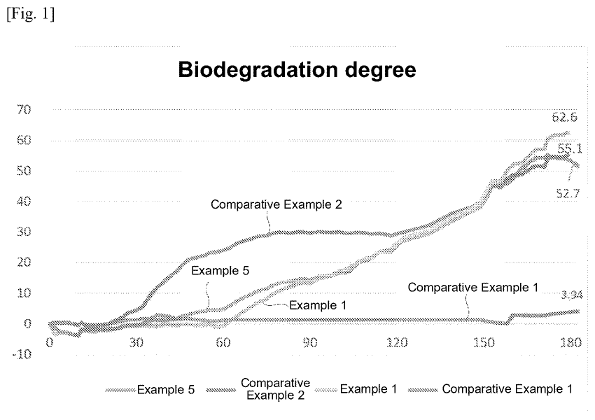

The results are shown in the following Table 1. The time-dependent change in biodegradation degree over 180 days is shown in the graph of FIG. 1.

TABLE 1

| | | | | | Comparative Example | | Example |
|---|---|---|---|---|---|---|---|
| | Remarks | | | | 1 | 2 | 1 |
| Polyol | Specific material | Molecular | Number of | Hydroxyl | | | |
| | | weight | functional | value | | | |
| | | | groups | | | | |
| Ether | Petroleum-derived polypropylene glycol polyol | 7000 | 3 | 24 | 100 | — | — |
| Polycaprolactone | Petroleum-derived polycaprolactone polyol 1 | 850 | 3 | 195 | — | 70 | 1 |
| Polycaprolactone | Petroleum-derived polycaprolactone polyol 2 | 530 | 2 | 224 | — | 30 | — |
| Biomass-derived | Biomass-derived refined castor oil | 950 | 2.7 | 160 | — | — | 50 |
| ester | (ricinoleic acid triglyceride) | | | | | | |
| Biomass-derived | Biomass-derived sebacic acid ester polyol | 2000 | 2 | 56 | — | — | 50 |
| ester | | | | | | | |
| Polyether primary | Petroleum-derived polyether amine | 5000 | 6 | 60 | — | — | 4.0 |
| amine | | | | (amine | | | |
| | | | | number) | | | |
| Catalyst | Tin neodecanoate | | | 0 | — | — | 5.0 |
| | TEDA (triethylenediamine) | | | 0 | 0.2 | 2.5 | 5.0 |
| | DBU (diazabicycloundecene) | | | 0 | I | 1.5 | 2.0 |
| | 1,2-dimethylimidazole (70%) + EG (30%) | | | 543 | — | — | 1.0 |
| Foam stabilizer | Silicone foam stabilizer | | | 0 | 0.5 | 0.2 | 1.8 |
| Foaming agent | Water | | | 6233 | 3.25 | 3 | 3 |
| Isocyanate | Petroleum-derived aromatic | 4,4′MDI:2,4MDI = 55:45 | | 33.6 | 42.9 | — | — |
| | isocyanate monomer (pure MDI) | | | | | | |
| | Diphenylmethane diisocyanate | | | (NCO%) | | | |
| | Petroleum-derived aliphatic isocyanate trimer | HDI trimer | | 23.2 | — | 121.5 | 88 |
| | Hexamethylene diisocyanate (HDI) trimer | | | (NCO%) | | | |
| Isocyanate index | | | | | 95 | 90 | 90 |
| Biodegradability | Soil burial test (%) after 45 days | | | | 2.1 | 34.5 | 21.5 |

| | | | | | |
|---|---|---|---|---|---|
| test | Biodegradation degree | After 45 days | 1.8 | 19 | 1.5 |
| | (ISO14855-2) | After 60 days | 2 | 23 | 1.8 |
| | (%) | After 180 days | 3.94 | 55.1 | 62.6 |

### Experimental Example 2

In Experimental Example 2, the influence of differences in raw materials used in the production of polyurethane foam on various physical properties was investigated.

### (1) Production of Polyurethane Foam

Each of the raw materials shown in Table 2 below was mixed to prepare a composition, which was then transferred to a mold and foamed to produce each of the polyurethane foams.

### (2) Evaluation

The produced polyurethane foams were evaluated for various physical properties using the following methods.

### [Reactivity]

The raw materials shown in Table 2 below were mixed to prepare a composition, which was then poured into a foaming box (open without a lid) and allowed to foam freely, and the rise time was confirmed.
x: Rise time exceeds 180 seconds, or thickening is insufficient, air bubbles escape, and foaming does not progress.
Δ: Rise time 120 to 180 seconds.
∘: Rise time less than 120 seconds.

### [Form Shape]

The raw materials shown in Table 2 below were mixed to prepare a composition, which was then poured into a foaming box (open and without a lid) and allowed to foam freely, and the state of the foam was confirmed.
x: The foam collapses during foam molding, or cracks appear on the exterior, resulting in poor appearance, or the cells on the cut surface inside the foam become rough.
Δ: Slight deformation during foam molding.
∘: The foam moldability, appearance, and cells are almost uniform, all of which are good.

### [Density]

After molding, the mold was cut into a sample having a size of 100 mm square and a thickness of 20 mm, and the density of the obtained sample was measured in accordance with JIS K7222:2005.

### [Hardness]

The hardness was measured using an Asker rubber hardness tester, type F.

### (3) Results

The results are shown in Table 2 below.

TABLE 2

| | Remarks | | | | Comparative Example | | Example | | | | | | |
|---|---|---|---|---|---|---|---|---|---|---|---|---|---|
| | | | | | 3 | 4 | 2 | 3 | 4 | 5 | 6 | 7 | 8 |
| Polyol | Specific material | Molecular | Number of | Hydroxyl | | | | | | | | | |
| | | weight | functional | value | | | | | | | | | |
| | | | groups | | | | | | | | | | |
| Ether | Petroleum-derived polypropylene glycol polyol | 7000 | 3 | 24 | 100 | — | — | — | — | — | — | — | — |
| Polycaprolactone | Petroleum-derived polycaprolactone polyol 1 | 850 | 3 | 195 | — | 70 | — | — | — | — | — | — | — |
| Polycaprolactone | Petroleum-derived polycaprolactone polyol 2 | 530 | 2 | 224 | — | 30 | — | 50 | — | — | — | — | — |
| Biomass-derived | Biomass-derived refined castor | 950 | 2.7 | 160 | — | — | 50 | 50 | 50 | 50 | 50 | 50 | 50 |
| ester | oil (ricinoleic acid triglyceride) | | | | | | | | | | | | |
| Biomass-derived | Biomass-derived sebacic acid ester polyol | 2000 | 2 | 56 | — | — | 50 | — | 50 | 50 | 50 | 50 | 50 |
| ester | | | | | | | | | | | | | |
| Polyether primary | Petroleum-derived polyether amine | 5000 | 6 | 60 | — | — | 4 | — | 4 | 4 | 0 | 0 | 0 |
| amine | | | | (amine | | | | | | | | | |
| | | | | number) | | | | | | | | | |
| Catalyst | Tin neodecanoate | | | 0 | — | — | 5 | — | — | 5 | — | 5 | 5 |
| | TEDA (triethylenediamine) | | | 0 | 0.2 | 2.5 | 5 | 5 | 2.5 | 5 | 2.5 | 5 | 5 |
| | DBU (diazabicycloundecene) | | | 0 | — | 1.5 | 2 | 1.5 | — | 2 | — | 2 | 2 |
| | 1,2-dimethylimidazole (70%) + EG (30%) | | | 543 | — | — | 1 | — | 1 | 1 | 1 | 1 | 1 |
| Foam stabilizer | Silicone foam stabilizer | | | 0 | 0.5 | 0.2 | 1.8 | 1.8 | 1.0 | 1.8 | 1.0 | 1.8 | 1.8 |
| Foaming agent | Water | | | 6233 | 3 | 3 | 3 | 3 | 3 | 3 | 3 | 3 | 3 |
| Isocyanate | Petroleum-derived aromatic | 4,4MDI: | | 33.6 | 42.9 | — | — | — | 49.4 | — | 50.2 | — | — |
| | isocyanate monomer (pure MDI) | 2,4MDI = 55:45 | | (NCO%) | | | | | | | | | |
| | Diphenylmethane diisocyanate | | | | | | | | | | | | |
| | Petroleum-derived aliphatic isocyanate trimer | HDI trimer | | 23.2 | — | 116.9 | 88.0 | 122.4 | — | — | — | 88.0 | — |
| | Hexamethylene diisocyanate (HDI) trimer | | | (NCO%) | | | | | | | | | |
| | Biomass-derived aliphatic isocyanate trimer | PDI trimer | | 23.7 | — | — | — | — | — | 86.6 | — | — | 86.6 |
| | Pentamethylene diisocyanate (PDI) trimer | | | (NC0%) | | | | | | | | | |
| Isocyanate index | | | | | 95 | 90 | 90 | 90 | 90 | 90 | 90 | 90 | 90 |
| Biomass degree | | | | | 0% | 0% | 40% | 25% | 50% | 75% | 50% | 40% | 75% |

| | | | | | | | | | | |
|---|---|---|---|---|---|---|---|---|---|---|
| Evaluation | Reactivity (foam freely) | ○ | ○ | ○ | ○ | ○ | ○ | Δ | Δ | Δ |
| | | | | | | | | (slow) | (slow) | (slow) |
| | Appearance (foam condition) (foam freely) | ○ | Δ | ○ | ○ | Δ | ○ | Δ | ○ | ○ |
| | | | (deformation) | | | (deformation) | | (deformation) | | |
| | Density kg/m (mold foaming) | 80.2 | 80.6 | 80.1 | 80.7 | 80.2 | 80.7 | 80.6 | 80.1 | 80.5 |
| | Hardness (mold foaming) | 41 | 55 | 66 | 49 | >100 | 61 | >100 | 67 | 65 |

### (4) Observations

As shown in Table 2, the reactivity tended to decrease in Examples 6 to 8 using a biomass-derived ester-based polyol, but the reactivity was improved by using a primary amine as shown in Examples 2, 4, and 5. Furthermore, as shown in Example 3, the reactivity could also be improved by using a polycaprolactone-based polyol and a biomass-derived ester-based polyol in combination as the polyol.

Furthermore, by using a biomass-derived isocyanate, the biomass degree could be increased to 75%.

1. A polyurethane foam having
a biodegradation degree after 45 days of 15% or less and
a biodegradation degree after 180 days of 30% or more
in the ISO14885-2 biodegradation degree test.

2. The polyurethane foam according to claim 1, wherein a biomass-derived ester polyol is used as a raw material.

3. The polyurethane foam according to claim 1, wherein a primary amine is used as a raw material.

4-7. (canceled)

8. The polyurethane foam according to claim 3, wherein the primary amine is one or more primary amines selected from primary amines having a number average molecular weight of 800 or more, polyester primary amines, and polyether primary amines.

9. The polyurethane foam according to claim 1,
wherein an isocyanate is used as a raw material, and
a petroleum-derived aliphatic isocyanate trimer or a biomass-derived aliphatic isocyanate is used as the isocyanate.

10. A composition for polyurethane foam production comprising
a polyol and
a biomass-derived isocyanate,
wherein
the polyol contains a castor oil-based polyol, and
the biomass-derived isocyanate contains a trimer of 1,5-pentamethylene diisocyanate (PDI) and/or lysine triisocyanate (LTI (2,6-Diisocyanato hexanoic acid 2-isocyanatoethyl ester)).

11. A polyurethane foam formed using the composition for polyurethane foam production according to claim 10.

12. The polyurethane foam according to claim 11, having a biomass degree of 50% or more.
